(19) United States
(12) Patent Application Publication
(10) Pub. No.: US 2015/0121236 A1
(43) Pub. Date: Apr. 30, 2015

(54) TELEPRESENCE MANAGEMENT SYSTEM AND METHOD

(71) Applicant: Edge Communications Solutions LLC, Plano, TX (US)

(72) Inventors: Terrence M. PECK, Islamorada, FL (US); Michael FORD, Plano, TX (US); William N. HAMEL, Honey Brook, PA (US)

(21) Appl. No.: 14/523,221

(22) Filed: Oct. 24, 2014

Related U.S. Application Data
(60) Provisional application No. 61/895,110, filed on Oct. 24, 2013.

(51) Int. Cl. H04L 12/24; G06F 3/0481

(52) U.S. Cl. CPC H04L 41/22; G06F 3/0481
USPC 715/736

(57) ABSTRACT

A director receives trigger data collected from a plurality of nodes, where the trigger data indicates a status of a node. The director processes the trigger data to add a display destination indicator and a display screen location indicator. A multicaster receives the processed data from the director and transmits the processed data based on the display destination indicator. A receiver includes a visual stimuli database and receives the transmitted data from the multicaster. The receiver associates the transmitted data with a selected visual stimuli to create a semiotic representation of the status of the node and transmits the semiotic representation to a display. The display receives and displays the semiotic representation in accordance with the display screen location indicator to represent the status of the node.

### CLAIM OF PRIORITY

This application claims priority to U.S. Provisional Application No. 61/895,110, filed on Oct. 24, 2013, the contents of which are incorporated herein by reference.

### FIELD OF THE INVENTION

The present invention relates generally to computer user interfaces for monitoring networks and/or equipment and, more specifically, to a user interface, system and method that enables users to interpret large amounts of information in compact visual fields.

### BACKGROUND

Traditional telecommunication and data carriers monitor the condition of their centralized network equipment by viewing status screens that require drill-down, performing telemetry analysis and then using the skills of individuals to diagnose events and begin mitigation. In most cases the process is reactionary rather than proactive and most often relies upon a customer calling in a trouble report to a call center. The traditional carrier has virtually no visibility of the customer experience. Indeed, monitoring each individual customer would be overwhelming if a large number of customers exist and prior art systems were used.

A need exists for a system and method that enables a user to proactively monitor and manage the telecommunications enterprises of customers from both the customer's and the network perspective in real time. A need also exists for a system and method that enables a user to visualize and manage a complex geographically distributed software defined network comprised of a large number of geographically separated network nodes exhibiting numerous states and condition changes in real time.

### BRIEF DESCRIPTION OF THE DRAWINGS

FIG. 1 is a block diagram illustrating an embodiment of the system of the present invention;

FIG. 2 is a flow chart illustrating the processing performed by the system of FIG. 1 in accordance with an embodiment of the method of the invention;

FIG. 3 is a perspective and block diagram view of an embodiment of the network operations station of the invention;

FIG. 4 shows an embodiment of the screen displayed by the largest monitor of the network operations station of FIG. 3;

FIG. 5 is a schematic representation of the screen of FIG. 4;

FIG. 6. is a diagram of one of the totem constellation groupings of FIG. 5;

FIG. 7 is a flow diagram illustrating examples of operation of the screen and totem constellation groupings of FIGS. 5 and 6;

FIG. 8 shows an embodiment of an interface for a training module for use with the system and method of the invention;

FIG. 9 illustrates a cluster of network operations stations.

### DETAILED DESCRIPTION OF EMBODIMENTS

Operating network nodes are continuously changing state and condition and human administrators who are responsible for their operation need to monitor the various states of nodes in real time. The state of a node is defined by certain descriptive attributes which describe the node's condition, and that are of interest to a human operator. For example, the state of a node may be defined by attributes such as “on or off,” “fast or slow,” “hot or cool,” “responding or not responding,” or any other possible condition that a human wants to monitor about that node. As a result, the combination of the potential number of states, the attributes of those states and the conditions represented by those attributes is virtually unlimited.

Examples of the need to identify large numbers of node state changes across multiple locations can be seen most vividly in circumstances where monitored nodes are associated together within a collective, or network, such as is the case within a telecommunications network, supply chain network, utility network, and other similar networks of associated nodes. In these environments, state changes that occur in nodes need to be quickly communicated to humans and differentiated in-context to each of the other nodes in the system.

Embodiments of the system and method of the present invention provide a real-time, event driven semiotic presentation by which human operators or users can systematically monitor, process and interpret the state and condition of software defined network nodes within the context of a geographically distributed system by using semiotic representations to convey their status to a human operator.

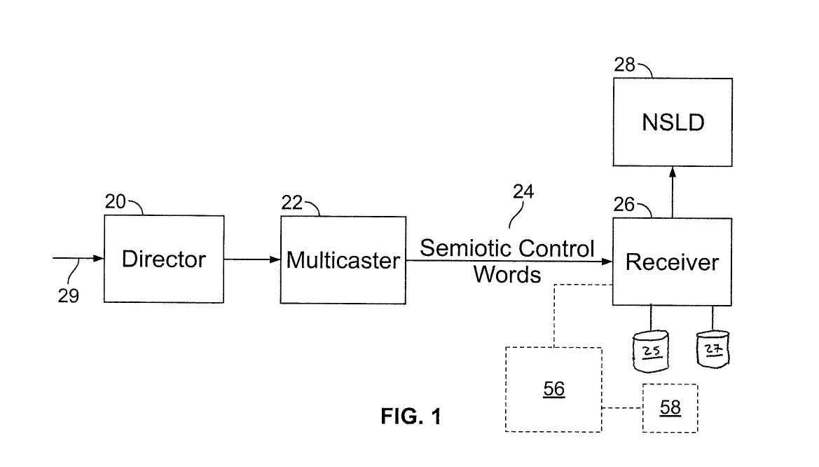

A block diagram of an embodiment of the system is illustrated in FIG. 1. As shown in FIG. 1, the system consists of five primary components: (1) a director 20, (2) a multicaster 22, (3) a semiotic control language or words 24, (4) a receiver 26 and (5) a display 28.

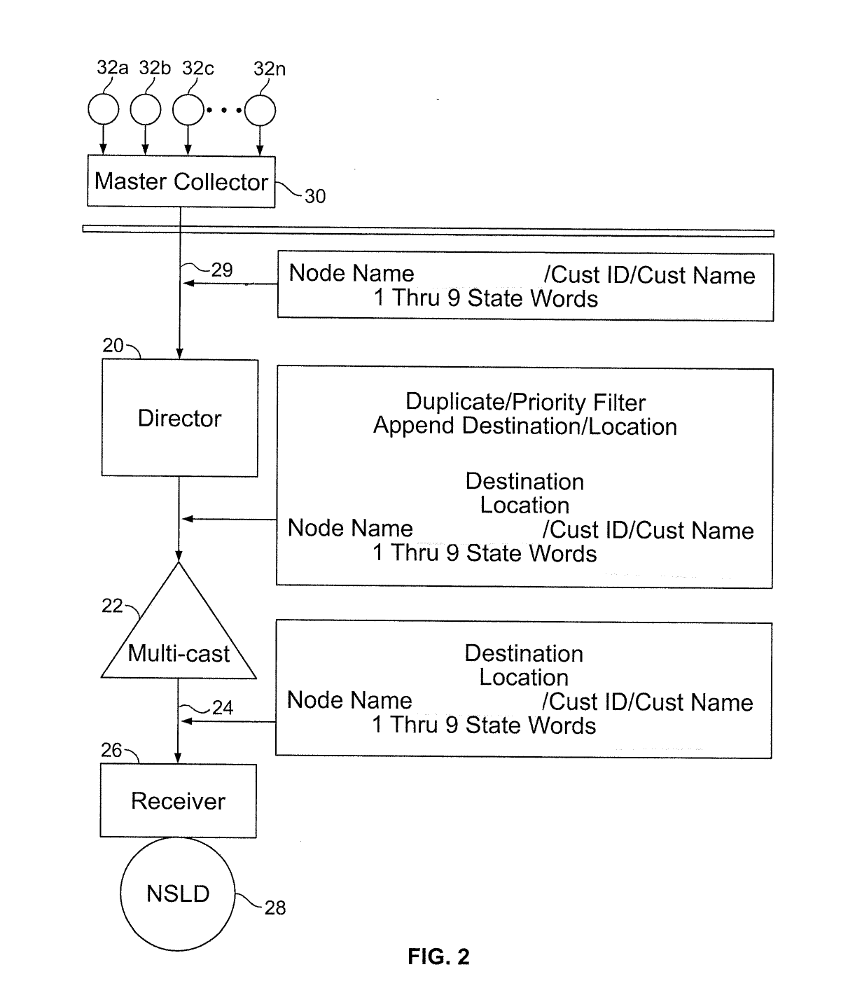

As shown in FIGS. 1 and 2, the director 20, which is a computer system, accepts event trigger words 29 from an outside source, such as a master collector system, indicated at 30 in FIG. 2, that collects data from a number of customer locations or nodes 32a-32n. The event trigger words 29 are made up of the Node Name, Customer ID and Customer Name, and 1-9 totem and/or state or event words each containing, for example, 0-4096 events.

The director 20 receives the event trigger words 29 and appends the display destination and screen location to assemble or create Semiotic Control Language (SCL) words (or semiotic words). In doing so, the director 20 uses logic to prevent duplication and assigns visual display priority from event triggers that it receives. The SCL is a set of instructions controlling the receiver's 26 display of visual (and optionally audio) stimuli by use of semiotic words. In one embodiment, the semiotic words 24 ultimately consist of a Node Name (8 position alpha numeric), Customer ID (8 position alpha numeric), Customer Name (30 position alpha numeric), totem word (2 position alpha numeric), event word (4 position alpha numeric), destination word (8 position alpha numeric) and screen location word (2 position alpha numeric).

The completed semiotic words are sent to the multicaster 22.

The multicaster 22, which is also a computer system, receives semiotic words from the director 20 and transmits (IP multicasts) the words 24 to all potential receivers 26 in accordance with the destination and screen location words. While only one receiver is illustrated in FIGS. 1 and 2, the system will typically include many more receivers based on the number of customer locations or nodes 32a-32n.

The receiver 26 is a computer provided with a database of visual stimuli (25 in FIG. 1) and (optionally) a database of audio stimuli (27 in FIG. 1). The database(s) contain visual and audio stimuli which correspond to the totem and event words of the multicasted semiotic words 24. The visual and audio stimuli are displayed as semiotic representations of node status (such as equipment or network status) in accordance with the semiotic words' unique display destination words and display screen location words and totem and event words. With regard to the latter, the receiver 26 is programmed to, upon receipt of a semiotic word 24, detect the totem word and the event word and identify the corresponding visual stimuli and (optional) audio stimuli from the databases 25 and 27.

The display 28 displays the semiotic words' audio visual imagery selected by the receiver 26 organized in nine position (screen location) totems, as will be explained below.

The system of FIGS. 1 and 2 communicates specific meaning to a system administration tribe member or user via the display 28 of FIGS. 1-3 within a focused service management culture by broadcasting the visual and audio stimuli in the form of semiotic representations which include totems. Totems are composed of the real-time visual animation objects and audio stimuli arranged in categorical constellations.

A totem communicates meanings through visual stimuli including as non-limiting examples:
Animation
Color
Dimensional perception and change
Movement
Pulsation
Proportional change
Rotation
Shape
Tempo
Texture

A totem may also provide meanings through audio stimuli including as non-limiting examples:
Tone
Pitch
Melody
Cadence
Harmonics
Instruments

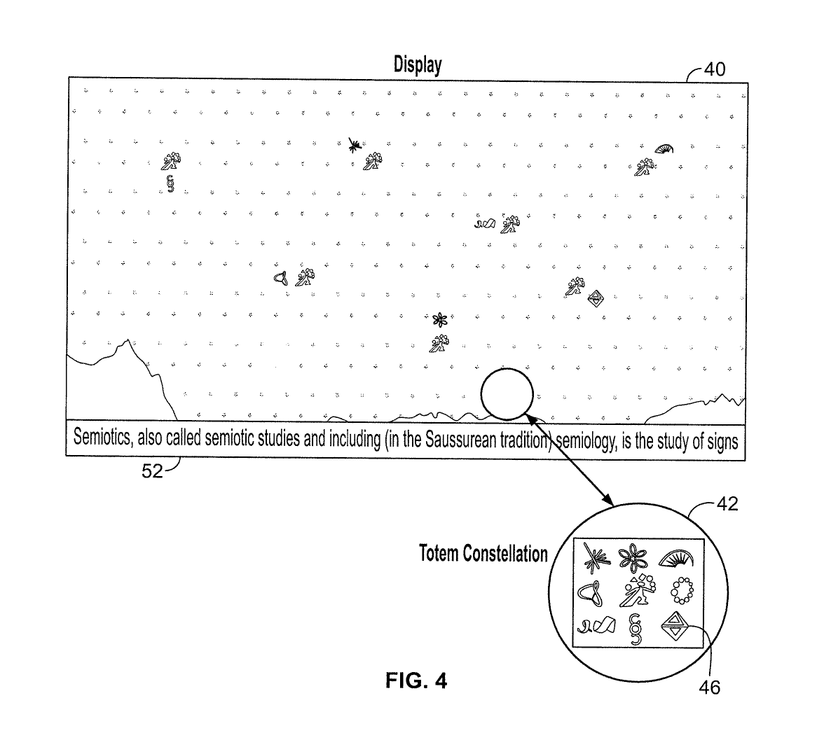

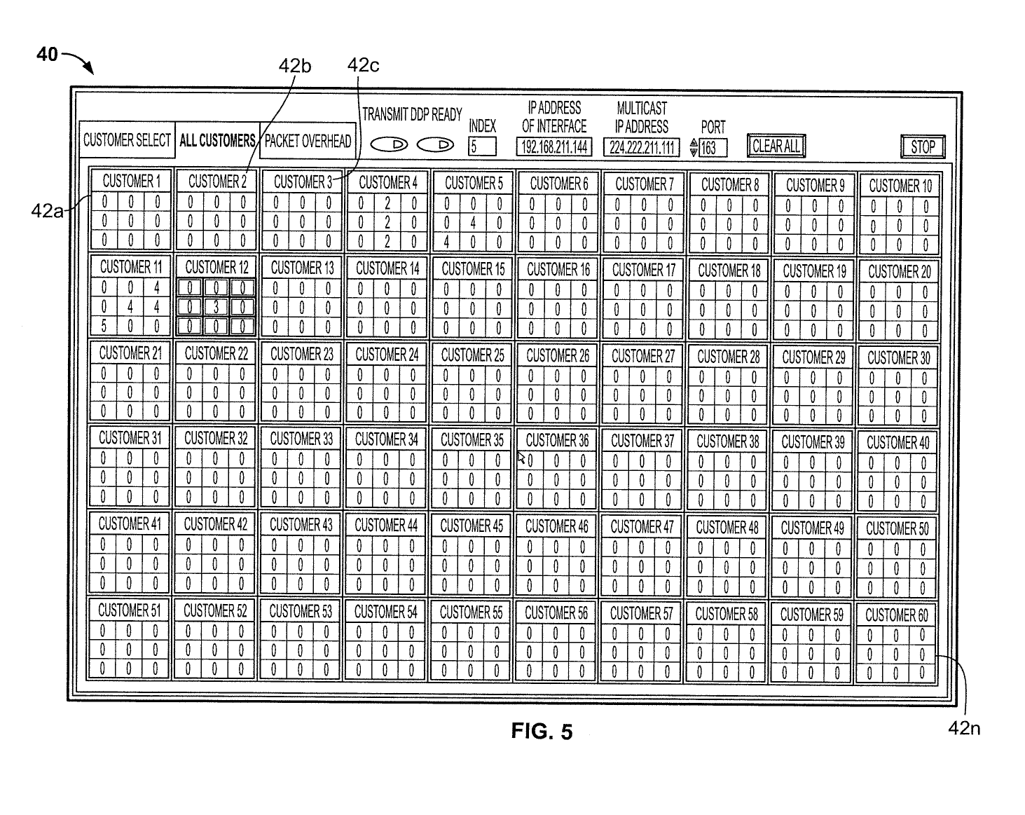

The system of FIGS. 1-3 enables an operator to visually interpret large amounts of state information for customer networks and/or equipment (including, but not limited to, devices and/or components) in compact visual fields, such as the one indicated at 40 in FIGS. 4 and 5. The screen or visual field 40 of FIGS. 4 and 5 is displayed on the display 28 of FIGS. 1-3. With reference to FIG. 4, a visual field 40 consists of a viewing display such as, but not limited to, a flat screen display where the multiple customer locations or nodes being monitored are arranged in totem constellation groupings 42. Each customer location or node is represented by a totem constellation having nine faces (such as the nine faces indicated at 46 in FIG. 4) with, for example, up to 4096 animated symbols per face.

The above system and display allow operators or users to visually interpret large amounts of information in compact visual fields using audio and visual stimuli. As illustrated in FIG. 5, the visual field 40 consists of a viewing display where, as an example only, sixty nodes are being monitored. As a result, the visual field 40 include sixty totem constellation groupings 42a-42n.

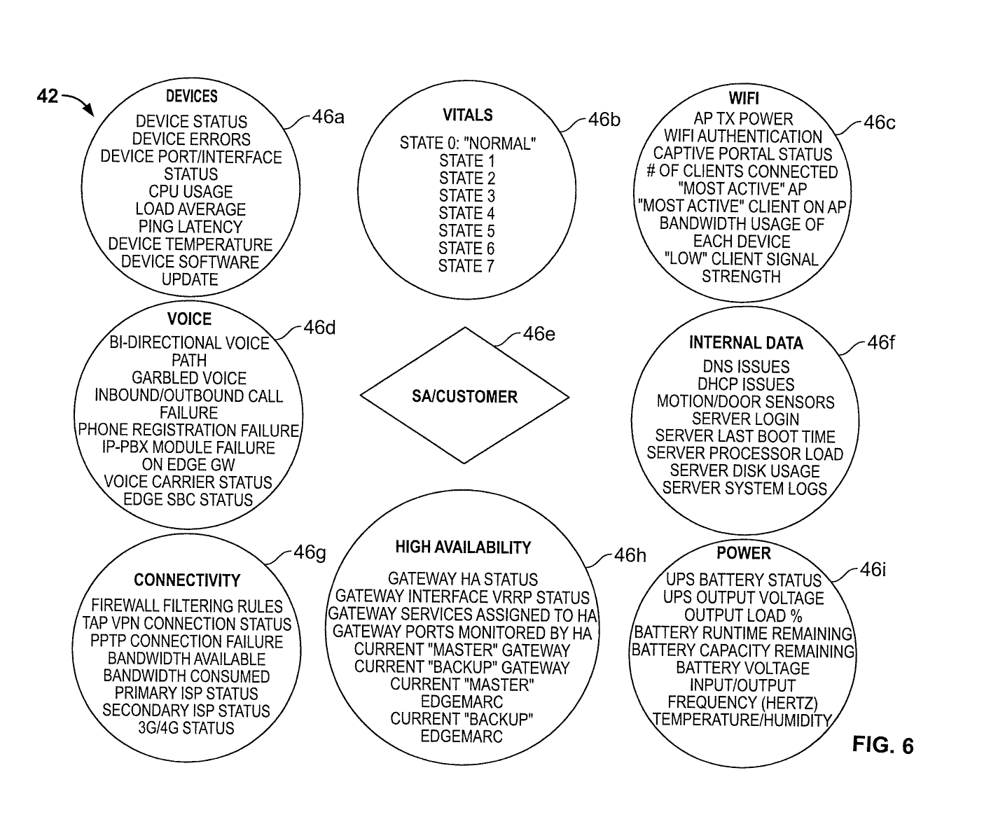

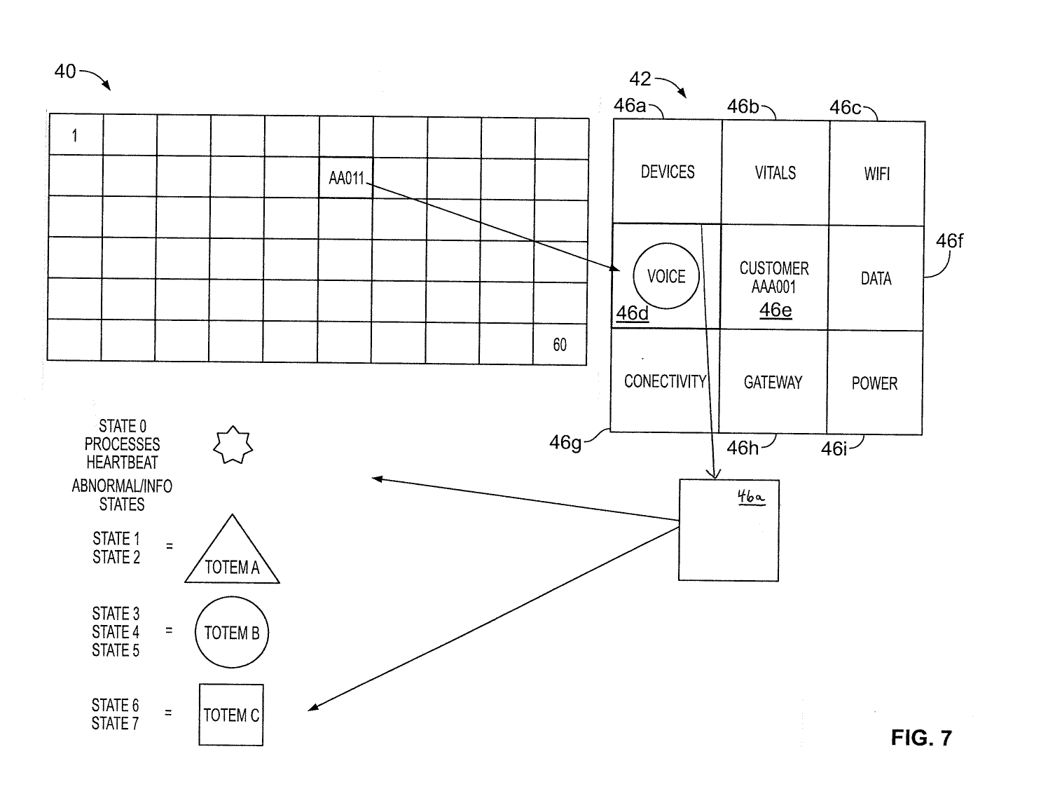

An example of a totem constellation grouping is provided in FIGS. 6 and 7, where the grouping has nine faces 46a-46i, where the customer or customer node is identified by the central face 46e. The remaining faces 46a-46d and 46f-46i indicate that the system is monitoring the status of the customer's equipment (46a), network vitals (46b), wifi (46c), voice communications (46d), internal data (46f), Internet connectivity (46g), system availability (46h) and power (46i). Each such remaining face may have, for example, seven states. For grouping 46a Devices (Device Status), for example, the seven states may be as follows:
State 1=Device Errors
State 2=Device Port/Interface Status
State 3=CPU Usage
State 4=Load Average
State 5=Ping Latency
State 6=Device Temperature
State 7=Device Software Update

As illustrated in FIG. 7, if State 1 or 2 is present, Totem A appears on the display screen for face 46a. The appearance of Totem A (color, shape, size, etc.) and/or an accompanying audio sound indicates which of State 1 or State 2 exists. As another example, if State 3, 4 or 5 is present for face 46a, Totem B appears on the display screen. The appearance of Totem B (color, shape, size, etc.) or an accompanying audio sound indicates which of State 3, State 4 or State 5 exists.

As illustrated in FIG. 4, a scrolling tickler 52 may be optionally provided across the bottom of the visual field 40. Such a tickler may provide information to the operator regarding system updates, urgent messages, etc. Alternative types of message ticklers may be added to the visual field 40.

The system may optionally be provided with a user training module, which may be, for example, a computer or application, indicated in phantom at 56 in FIG. 1. The module is useful in training users in identifying and responding to various status conditions presented by the visual field displayed by the system display 28. While the training module is shown as a separate component connected to the receiver 26 of the system, it may be incorporated into or connected to any of the system components.

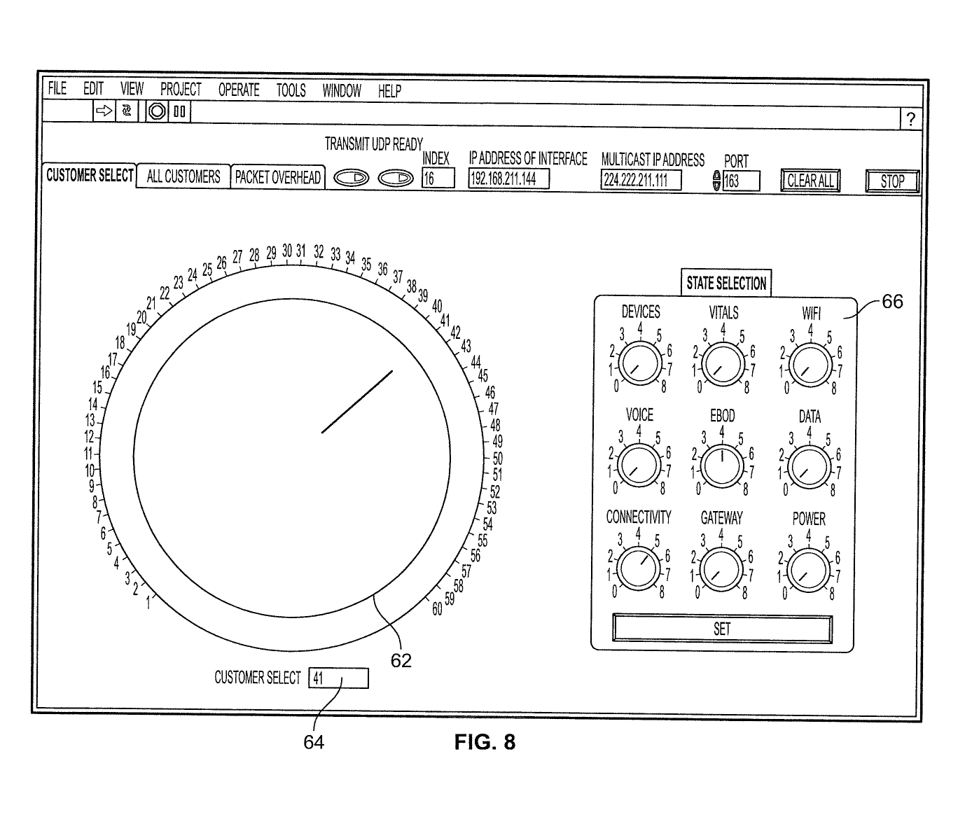

As illustrated in FIG. 1, the training module features an interface accessed by a training module workstation 58, which includes a display. The training module display of FIG. 1 presents to the trainer the screen shown in FIG. 8. With reference to FIG. 8, the screen includes a primary knob icon 62 that may be manipulated by the trainer using the workstation to select a node or customer number. The selected node or customer appears in a window 64. In the illustrated example, customer or node 41 has been selected. The screen of FIG. 8 also includes secondary knob icons 66 which correspond to faces 46a-46i of FIGS. 6 and 7. Using the secondary knob icons 66, the trainer may select any of the states for each of the faces of a totem constellation grouping (42 of FIGS. 5-7). The training module 56 may alternatively take the form of a hardware device having the appearance of the screen of FIG. 8.

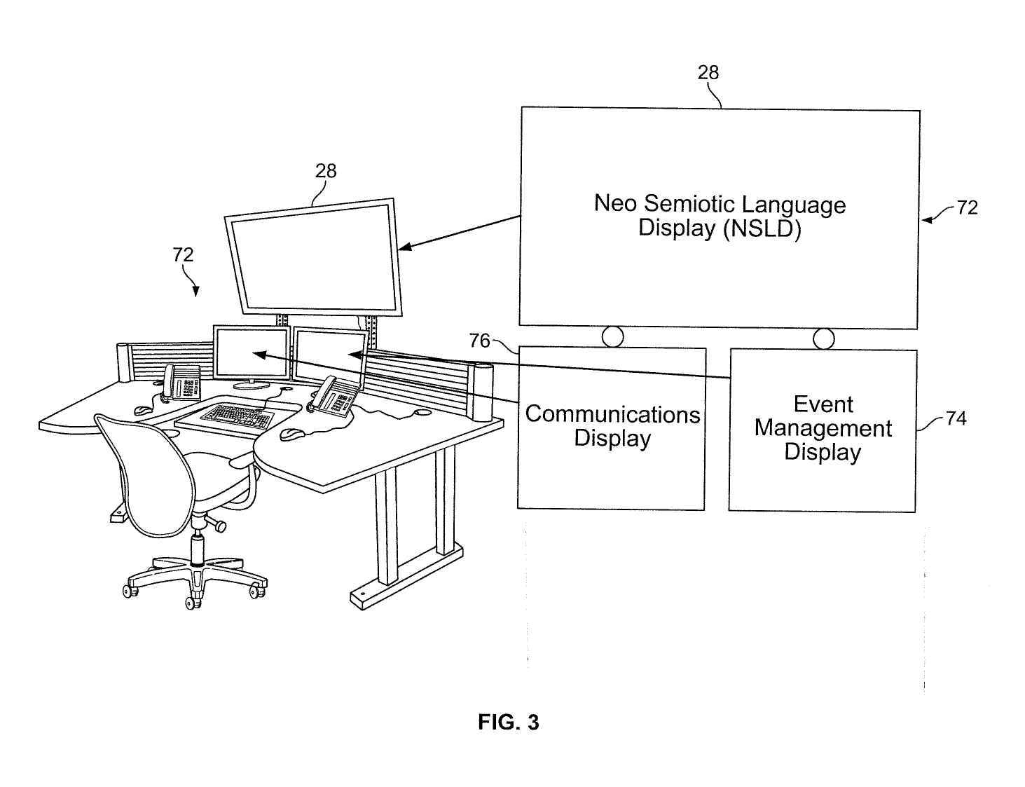

Returning to FIG. 3, the display 28 described above is preferably part of a network operations station (“NOS”), indicated in general at 72. The NOS is a purpose built station for operations personnel. The station is preferably powered by a special operations module and has a redundant high availability gateway, three computing environments and multiple communications capabilities. The three screens or displays present, 1) a current visualization of all customers that the operator is responsible for along with the current condition of their environment (display 28 discussed above), 2) access to an event detection and intervention system interface (display 74 of FIGS. 3), and 3) access to business software and individual communications (display 76 of FIG. 3). This design enables deploying and locating network managers at multiple physical locations.

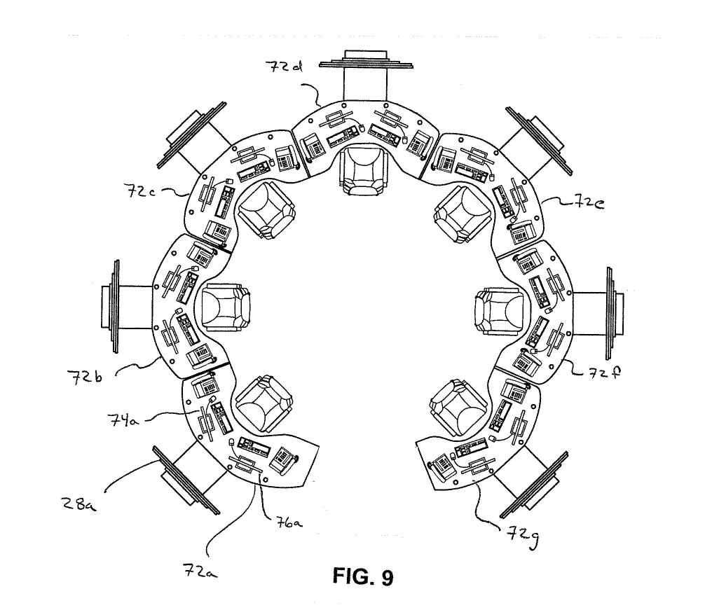

To maximize interaction and collaboration among operations staff members, network operations stations 72a-72g may be joined together into self-contained clusters, as illustrated in FIG. 9, that allow seven network engineers to work and communicate together closely. This fosters sharing and reviewing of customer experiences, replicating and resolving problems. Operations centers can be replicated in any geographic location by adding these clusters of network operation stations.

The system and method described above thus portrays the real time status and changes in state for each device that is monitored onto the SLD that is part of each network operations station (FIG. 3). As described previously, our network operation stations are the physical work centers that give our operators the tools to deliver highly-automated, fully-managed services. This approach requires a considerably smaller viewing area to efficiently monitor and quickly interpret the state of large and complex systems of devices, and allows our network operations staff to monitor more locations and devices more accurately and effectively than with any other method or technologies.

The system allows users to proactively monitor and manage the telecommunications enterprises of customers from both the customer's and the network perspective in real time. This approach dramatically accelerates the entire detection, intervention and mitigation process.

While the preferred embodiments of the invention have been shown and described, it will be apparent to those skilled in the art that changes and modifications may be made therein without departing from the spirit of the invention, the scope of which is defined by the following claims.

What is claimed is:

1. A system for monitoring a plurality of nodes of a network comprising:
a) a director for receiving trigger data collected from the plurality of nodes, said trigger data indicating a status of a node, said director processing the trigger data to add a display destination indicator and a display screen location indicator;
b) a multicaster receiving the processed data from the director and transmitting the processed data based on the display destination indicator;
c) a receiver including a visual stimuli database, said receiver receiving the transmitted data from the multicaster, associating the transmitted data with a selected visual stimuli to create a semiotic representation of the status of the node and transmitting the semiotic representation; and
d) a display receiving the semiotic representation from the receiver and displaying the semiotic representation in accordance with the display screen location indicator to represent the status of the node.

2. The system of claim 1 wherein the receiver also includes an audio stimuli database and the semiotic representation includes audio visual stimuli that is displayed on the display.

3. The system of claim 1 wherein the display includes a plurality of screen positions where each screen position corresponds to a node.

4. The system of claim 3 wherein each node corresponds to an identifier selected from the group consisting of a customer, a location, and a group.

5. The system of claim 3 wherein each screen position includes a plurality of screen locations and wherein the semiotic representation is displayed at one of the plurality of screen locations.

6. The system of claim 5 wherein the each screen position includes nine screen locations with a central location identifying the node.

7. The system of claim 1 wherein each semiotic representation includes a totem.

8. The system of claim 1 wherein the processed data includes a semiotic word identifying the node, an event corresponding to the network or equipment, a receiver destination and a display screen location.

9. The system of claim 1 wherein the status of the node includes a status of equipment at the node.

10. The system of claim 1 wherein the status of the node includes a status of a network at the node.

11. The system of claim 1 wherein the status of the node includes a status of a service selected from the group consisting of wifi, voice communications, Internet connectivity, system availability and power.

12. A user interface for monitoring a plurality of nodes of a network comprising:
a) a display:
b) said display presenting to a user a screen including:
i. a plurality of totem constellation groupings, each totem constellation grouping corresponding to one of the plurality of nodes;
ii. each totem constellation grouping including a plurality of faces, each face for monitoring an aspect of the node and having a plurality of states indicated by a visual appearance of the face.

13. The user interface of claim 12 wherein a state of a face is also indicated by an audio stimuli.

14. The user interface of claim 13 wherein each totem constellation grouping corresponds to a customer, location, or group.

15. The user interface of claim 12 wherein the aspect of the node includes a status of equipment at the node.

16. The user interface of claim 12 wherein the aspect of the node includes a status of a network at the node.

17. The user interface of claim 12 wherein the aspect of the node includes a status of a service selected from the group consisting of wifi, voice communications, Internet connectivity, system availability and power.

18. A method of monitoring a plurality of nodes of a network comprising the steps of:
a) receiving trigger data collected from the plurality of nodes, said trigger data indicating a status of a node,
b) processing the trigger data to add a display destination indicator and a display screen location indicator;
c) transmitting the processed data based on the display destination indicator;
d) associating the transmitted data with a selected visual stimuli to create a semiotic representation of the status of the node; and
e) displaying the semiotic representation in accordance with the display screen location indicator to represent the status of the node.

19. The method of claim 18 wherein the status of the node includes a status of equipment at the node.

20. The method of claim 18 wherein the status of the node includes a status of a network at the node.
